(19) United States
(12) Patent Application Publication
(10) Pub. No.: US 2008/0240854 A1
(43) Pub. Date: Oct. 2, 2008

(54) Cover for Gates and Turnstiles

(76) Inventor: Devon T. Binns, Green Pond, NJ (US)

Correspondence Address: HODGSON RUSS LLP;THE GUARANTY BUILDING, 140 PEARL STREET, SUITE 100, BUFFALO, NY, 14202-4040, US

(21) Appl. No.: 12/055,858

(22) Filed: Mar. 26, 2008

Related U.S. Application Data
(60) Provisional application No. 60/920,678, filed on Mar. 29, 2007.
(60) Provisional application No. 60/973,851, filed on Sep. 20, 2007.

(51) Int. Cl. E01F 13/00; E06B 11/08; G06Q 90/00

(52) U.S. Cl. 404/6; 49/46; 705/500

(57) ABSTRACT

A turnstile cover that has a body portion that is for being positioned on the arms of a turnstile. The cover has an outer layer with and exterior surface has an inner layer of padding, or the cover may be a single layer. The cover has an opening and is hollow, such that it may be slid over the arm of a turnstile. The padding advantageously provides for reduced impact when a person walks into the arm of the turnstile. The turnstile cover may advantageously be slid onto the arms of turnstiles found in subways, sporting venues, schools, etc. The exterior surface has indicia, for example printed indicia that may include advertising, logos, messages, public service messages, sales, and other desirable indicia. The cover and/or space on the cover is sold to interested companies and/or individuals for a fee. A traffic control gate cover is also provided.

### CROSS REFERENCE TO RELATED APPLICATIONS

This application claims priority to U.S. provisional patent application Ser. No. 60/920,678, filed Mar. 29, 2007 to Binns, for a Turnstile Cover, the contents of which are hereby incorporated by reference, and this application claims priority to U.S. provisional patent application Ser. No. 60/973,851, filed Sep. 20, 2007 to Binns, for a Traffic Control Gate Cover, the contents of which are hereby incorporated by reference.

### BACKGROUND

Turnstiles are used for regulating the flow of people at many different venues and events. In particular, the turnstile has a turnstile housing from which extends rotatable arms or bars that are usually metal, and the arms are bars are caused to rotate as a person walks through and pushes against the arms. The person must press his or her body against a hard inflexible turnstile arm in order to pass through the turnstile, and this is often painful for some people. In addition, some turnstiles are equipped with swipe card systems wherein a person swipes a card through a turnstile reader, thus allowing the turnstile to rotate. If the reader does not recognize the card or there is a miss-swipe of the card, then the person may walk into a locked turnstile and experience significant pain. The person may then re-swipe the card trough the reader to thus allow the turnstile arms to rotate. There are also traffic control gates are used for controlling traffic, for example vehicular traffic, and these traffic control gates raise and lower to all traffic to pass, or they may swing out of the way to allow for a vehicle to pass.

What is need is a user friendly turnstile. In addition, there is a need for a way to capitalize on the fact that a great number of people that pass through traffic control gates and turnstiles.

### SUMMARY

In one of the preferred embodiments, there is provided a turnstile cover that has a body that is adapted to be positioned over the arms of a turnstile. In one of the preferred embodiments, the cover is a single layer of material that serves as both a cover and padding. In another preferred embodiment the cover has an outer layer with and exterior surface and may comprises a material, for example, synthetic leather, plastic, fabric, woven and non-woven fabrics, leather and other suitable durable materials. The cover has an inner layer of padding. The cover has an opening and is hollow, such that it is capable of being slid over the arm of a turnstile. The padding advantageously provides for reduced impact when a person walks into the arm of the turnstile. In another preferred embodiment, the turnstile cover comprises a tube made of open-cell neoprene rubber or other suitable material with at least one end being open. The turnstile cover may be made in virtually any color and in one of the preferred embodiments is used for corporate advertising, i.e., the exterior surface of the cover has advertising indicia printed thereon.

The turnstile cover is advantageously slid onto the arms of turnstiles found in subways, transportation authorities, sporting venues, schools, etc. The exterior surface has indicia, for example printed indicia that includes advertising, logos, messages, public service messages, sales, and other desired indicia. The turnstile cover is sold to interested companies and/or individuals interested in advertising to every person walking through the turnstile. The turnstile cover has at least a dual purpose. First, some turnstiles have readers and the user swipes a card through the reader, thus allowing the turnstile arms to be turned or rotated. If there is a problem, i.e., the reader fails to read the swipe card or there is a problem with the swipe card, the person will nevertheless walk into the turnstile and come to an abrupt halt, because the turnstile arms will not rotate. This is often quite painful, because the turnstile arms are made of metal. The user may then again swipe the card through the reader, and if assuming there is no problem, the person will be able to walk through the turnstile. The padded turnstile cover protects the person from a painful impact in such instances. Second, the turnstile cover is also used for generating advertising revenue. In particular, advertising space on the exterior surface of the turnstile cover is, in one of the preferred embodiments, sold to mass transit authorities, sporting arenas, sport venues, amusement parks, casino, transit industries, museums or other venue where it is positioned. The turnstile cover is capable of being made with different colors, for example depending on what corporation purchases the advertising space. The turnstile cover has an open end and is slid over the turnstile arm. Each turnstile arm may have a turnstile cover.

In another preferred embodiment there is a traffic control system having a traffic control gate (or barrier), and a gate cover is provided that is adapted to be slid on and off of a traffic control gate arm, and has the shape of a tube. The traffic control gate cover may be made out of a section of fire hose with one of the ends thereof closed by sewing or other suitable means and the other end being open, or may the gate cover may be made of any of the materials previously described in connection with the turnstile cover, for example nylon, synthetic leather, plastic, fabric, woven and non-woven materials, leather, rubber, a tube of open-cell neoprene and other suitable durable materials. Both ends of the gate cover may be open, or one of the ends may be sealed or closed. The open end of the gate cover is slid onto the gate arm of the vehicle control barrier system. The gate cover is made of a thermoplastic or synthetic rubber liner combined with a closely woven textile jacket disposed around the liner. The jacket may comprise cotton and polyester or synthetic materials. The exterior surface of the gate cover provides advertising space, and advertising in the form of printed indicia covers the exterior surface of the gate cover. The advertising space is sold to interested companies/individuals. All forms of advertising (advertising understood to mean all forms of paid communication through a non-personal medium in which the sponsor is identified and the message is controlled, and variations include publicity, public relations, product placement, sponsorship, underwriting, and sales promotions). This same type of advertising may be used on the turnstile cover. The advertising may include promotional information, a public service message, emergency information, a design, a corporate logo, a team logo, a pattern, a slogan, ideas and printed text. These printed logos, regular advertising, slogans, public service messages, etc. The gate cover is therefore usable to generate advertising revenue for a mass transit authority, a sporting arena, parking lots, parking ramps, or other venue where the traffic control gate is positioned. The traffic control gate cover is capable of being made with different colors depending on what corporations purchase the advertising space.

In addition, virtually any type of flexible resilient fire hose may be used to make the traffic control gate, for example, a fire hose having a double jacket constructions include a second closely woven jacket for extra durability. In another preferred embodiment, the gate cover may comprise a covered fire hose having an all-polyester single jacket hose spirally wrapped with a neoprene or synthetic rubber outer covering.

### BRIEF DESCRIPTION OF THE DRAWING FIGURES

Throughout the drawing figures the same surfaces, structures, parts, elements are components are designated by the same reference numeral throughout.

FIG. 1 is a perspective view of the cover.

FIG. 2 is a front elevational view of the cover.

FIG. 3 is a rear elevational view of the cover.

FIG. 4 is a top plan view of the cover.

FIG. 4A is front elevational view of another embodiment of the cover having a taper.

FIG. 5 is an enlarged left end elevational view of the cover.

FIG. 6 is an enlarged right end elevational view of the cover.

FIG. 7 is a diagrammatic view of the cover before it is installed on the arm of a turnstile.

FIG. 7A is a sectional view of the turnstile arm taken along line A-A of FIG. 7.

FIG. 8 is a diagrammatic view of the cover installed on the arm of a turnstile.

FIG. 9 is a diagrammatic view showing the position of the inner and outer layers prior to being joined.

FIG. 10 is a perspective view of the inner and outer layers after having been joined.

FIG. 11 is a diagrammatic view of the cover before the components are joined.

FIG. 11A is a perspective view of another embodiment of the turnstile cover made.

FIG. 12 is a front elevational view of the traffic control gate cover.

FIG. 13 is an enlarged sectional view of the traffic control gate cover taken along line B-B of FIG. 12.

FIG. 13A is an enlarged end view of the traffic control gate cover.

FIG. 14 is a diagrammatic view of a traffic control system having a traffic control gate illustrating the manner in which the traffic control gate cover is slid onto the traffic control gate.

FIG. 15 is a perspective view of a traffic control system with a the traffic control gate cover positioned on the traffic control gate.

FIG. 16 is a sectional view taken along line C-C of FIG. 15.

FIG. 17 is a sectional view of another embodiment wherein the traffic control gate cover is fitted on a traffic control gate having a rectangular cross section.

FIG. 18 is a perspective view of another embodiment made of the gate cover.

### DETAILED DESCRIPTION

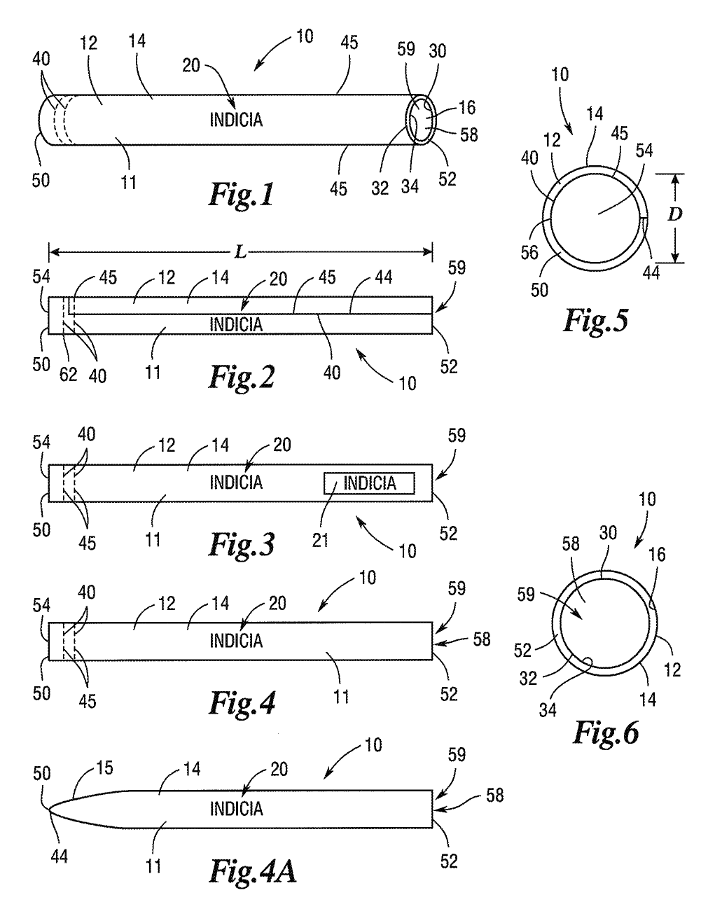

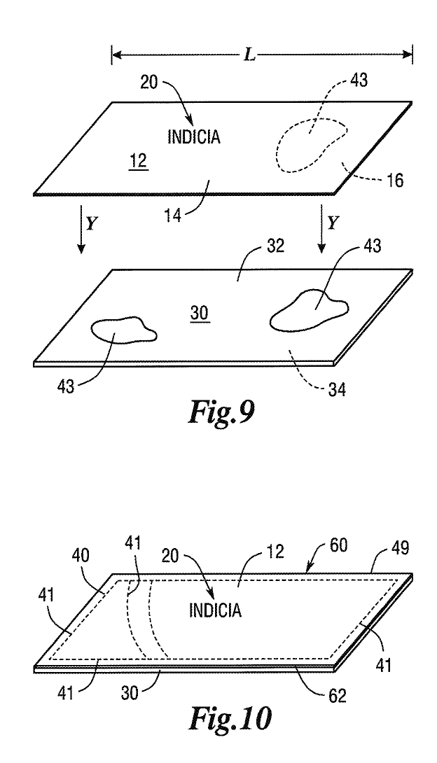

As shown in FIGS. 1-7, there is a turnstile cover 10 (also referred to throughout this description as cover 10) for use with a turnstile 100. The turnstile cover 10 has a body portion 11 having an outer layer 12. The outer layer 12 has an exterior surface 14 and a opposed inner surface 16, as best shown in FIG. 9. The outer layer 12 may comprise synthetic leather, plastic, woven materials, fabrics, leather, rubber and combinations thereof. Other suitable materials may be used for the outer layer 12. The outer layer 12 is preferably made of a flexible material. The exterior surface 14 of the outer layer 12 has indicia 20 (also referred to herein as printed indicia 20) as shown in FIGS. 1-4A, 7-11. The printed indicia 20 may include advertising, promotional information, a public service message, trademarks, emergency information, and combinations thereof. The printed indicia 20 may also be virtually any suitable indicia required for a particular application. In other preferred embodiments, the printed indicia 20 may comprise designs, corporate logos, team logos and/or patterns. The printed indicia 20 may also comprise designs making the outer layer 12 visually pleasing, or may be seasonal, for example snowflakes for the winter months. Thus, there virtually no limit to types of printed indicia 20 that may be applied on the exterior surface 14 of the outer layer 12. In addition, as shown in FIG. 3, the exterior surface 14 of the outer layer 12 may also have a sticker 21 adhered to it with an adhesive, and the sticker 21 may have virtually any printed indicia 21, including the indicia 20 described above.

The body portion 11 further includes an inner layer 30, as shown in FIGS. 1, 6 and 9, and the inner layer 30 has a first inner layer surface 32 and an opposed second inner layer surface 34. The first inner layer surface 32 abuts the inner surface 16 of the outer layer 12, and the inner and outer layers 12, 30, respectively, are joined. As shown in FIG. 10, the inner and outer layers 12, 30 are, in one of the preferred embodiments, joined to one another with thread 40 along stitch lines 41. In another preferred embodiment, an adhesive 43 may be applied to the first inner layer surface 32 and/or the inner surface 16 of the outer layer 12 to join the inner layer 30 and outer layer 12. Or, thread and adhesives may be used to join the inner and outer layers 12, 30. The adhesive 43 may be waterproof. Adhesives and waterproof adhesives are well known to those having ordinary skill in the art. In one of the preferred embodiments, the inner layer 30 is a made of padding, and the padding is a cushioning-type material, for example flexible foam, open-cell neoprene or other soft flexible material. Other suitable materials may be used for the inner layer 30. The inner layer 30 is preferably a padding that is made of a resilient sponge-like foam material such that the padding returns to its original shape after having been deformed. In another preferred embodiment, the padding may be flexible polyurethane foam. The inner layer 30 advantageously absorbs energy as a person walks or otherwise moves through the turnstile 100. Padding, flexible resilient foams, open-cell neoprene, and flexible polyurethane foam are well know known to those having ordinary skill in the art. In other preferred embodiments the inner layer 30 may comprise soft fabrics, natural or synthetic materials, rubber and other flexible soft materials that are capable of providing cushioning and/or absorbing energy.

As shown in FIGS. 5, 7 and 8, the body portion 11 of the turnstile cover 10 has opposed first and second ends 50, 52, and has a generally tubular shape, and the second end 52 is open. The turnstile cover 10 also has an end member 54 that is joined to the first cover end 50. There is an end seam 56 where the end member 54 is joined to the body portion 11 at the first end 50. The end member 54 may be positioned internal to the tubular body 11 and joined to the tubular body 11 with thread 40 along a stitch line 45 that extends along the end seam 56. In another preferred embodiment, the end member 54 is attached directly to the first cover end 50 with, for example, an adhesive. As shown in FIG. 6, the second end 52 defines a turnstile arm opening 58 that leads to a turnstile arm recess 59 As best shown in FIG. 1, the end member 54 has inner and outer layers 30a, 12a, respectively, comprising the same type of materials as described above in connection with the outer layer 12, and the inner layer 30. In other preferred embodiments the end member 54 may have a single layer, and the single layer may be made of any of the above described materials described above in connection with the outer layer 12. In another preferred embodiment, the end member 54 is absent, and the body portion 11 has a taper 15 that extends to the first end 50, and the taper 15 is sewn together at the first end 50 along a seam 44 with thread or adhesives, as shown in FIG. 4A. In other preferred embodiments, the end member 54 is absent, such that the turnstile cover 10 has turnstile arm openings 58 at each of the first and second ends 50, 52.

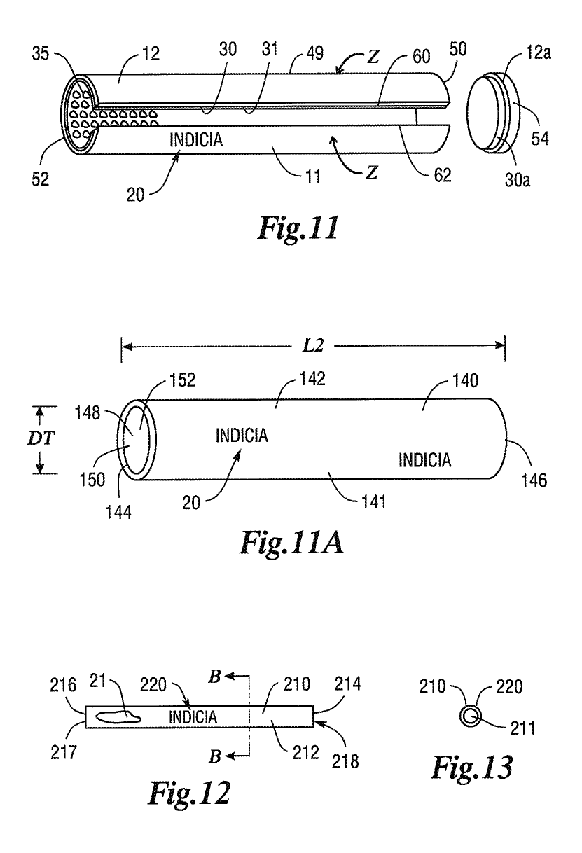

As shown in FIG. 2 there is a seam 44 that extends longitudinally the length, designated L, of the turnstile cover 10. The length L of the cover is preferably substantially the same as the length the turnstile arm 112 and designated LA in FIG. 8, but in other embodiments it may be more or less. The longitudinal seam 44 is formed when the first and second seam edges 60, 62, (shown in FIGS. 10 and 11) are brought together and joined. The longitudinal seam 44 is sewn together with thread 40 along a stitch line 45, or the longitudinal seam 44 may be joined with adhesives applied to the first and second seam edges 60, 62. The adhesives may be waterproof. Adhesives and waterproof adhesives are well known to those having ordinary skill in the art. The body portion 11 is thus formed when the first and second seam edges 60, 62 are joined together in the above described manner. The body portion 11 is in the shape of a hollow cylinder, and in one of the preferred embodiments a hollow right cylinder, as shown in FIGS. 1-6 and 7 and 8. In addition, because the body portion 11 is made of flexible materials it may be flattened without being damaged.

As shown in FIG. 9, to make the turnstile cover 10, the inner and outer layers 30, 12, are cut to size. The length L of the inner and outer layers 30, 12 is substantially the same, as shown in FIG. 9. The inner and outer layers 30, 12 are moved in a direction toward one another as indicated by the arrows designated Y. Next, the inner and outer layers 30, 12, are joined to one another by sewing with thread 40 along stitch lines 45, as shown in FIG. 10 to make a sheet of material 49, or they may be joined with adhesives which may be waterproof adhesives. The first and second seam edges 60, 62, of the sheet 49 are rolled together as shown in FIG. 11, as indicated by the arrows designated Z in FIG. 11. The rolled sheet of material 49 is sewn together along the along the stitch line 45 that extends along the longitudinal seam 44 to form the body portion 11. The end member 54 is positioned in the first cover end 50 of the body portion 11, and sewn to the body portion 11 along the end seam 56 and sewn to the body portion 11 with thread 40 that extends through the outer and inner layers 12, 30, and into the end member 54, as shown in FIG. 1. The indicia 20 is applied to the exterior surface 14 of the turnstile cover 10 after assembly of the turnstile cover 10, or may be applied to the exterior surface 14 prior to assembly of the cover, as shown in FIG. 9. The indicia 20 may applied by painting, printing and known methods of applying inks, dyes and paints and the like to a substrate. Or, the indicia 20 may be screen printed on the exterior surface 14, or burned into the exterior surface 14. Methods for applying inks, paints, dyes, screen prints to a substrate and burning images on substrates are well known to those having ordinary skill in the art. The turnstile cover 10 is advantageously lightweight, flexible and resilient, and has the shape of a hollow cylinder with a closed end. The cylindrical shape may be in the shape of a right cylinder, as shown. The turnstile cover 10 may be advantageously folded and flattened for shipment and storage, and will return to its pre-deformed shape when unfolded. The turnstile cover 10 is also advantageously inexpensive to fabricate and manufacture. In addition, the manufacturing costs associated with the manufacture of the turnstile cover 10 may be advantageously offset by advertising revenue generated by the sale of advertising space that is available on the entire exterior surface 14 of the turnstile cover 10, to companies, public service authorities, individuals, political organizations, etc. Thus, manufacturing costs are or may be advantageously offset by the high revenue generated by selling the advertising space available on the exterior surface 14 to interested parties, such that the sale of advertising space and/or covers 10 generates a stream of income that may be significantly greater than the costs associated with manufacturing the turnstile covers 10.

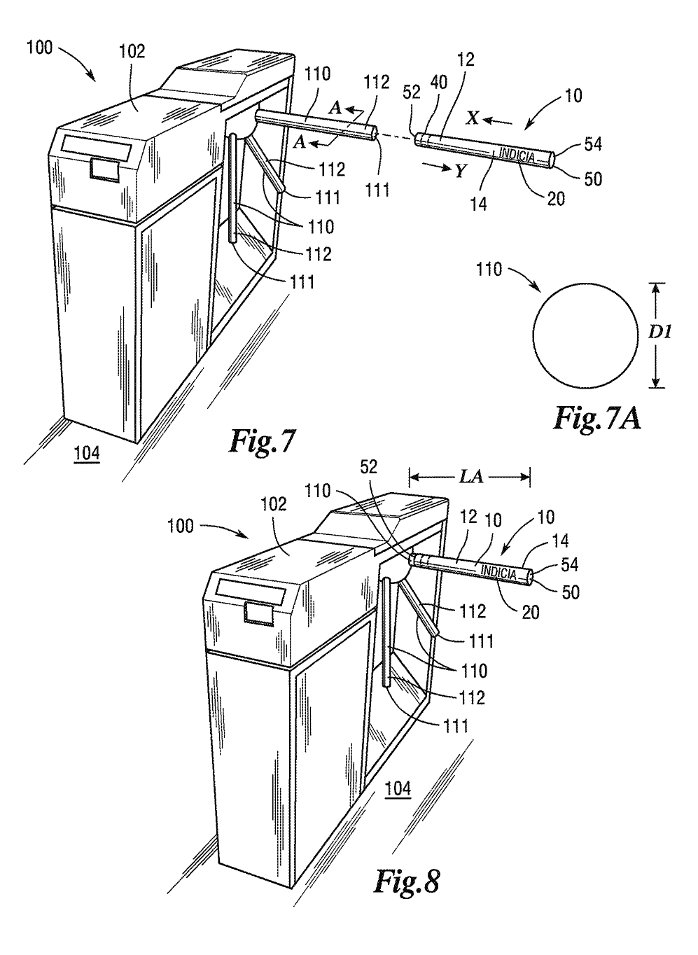

As shown in FIGS. 7 and 8, there is a turnstile 100 having a housing 102 which is supported on the ground/floor 104. The turnstile 100 has arms 110, and each arm has an end tip 111 and an exterior surface 112. The arms 110 are supported by the housing 102. The arms 110 are mounted to the housing 102 such that they are capable of being rotated when a force is applied to the arms 110. The force may be provided by a person walking through the turnstile 100. Turnstiles 100, turnstile arms 110 that are capable of rotating, and the use, construction and operation of turnstiles 100 are well known to those having ordinary skill in the art and therefore are not described herein.

In use, the turnstile arm opening 58 in the turnstile cover 10 that leads to the turnstile arm recess 59 is moved adjacent to the end tip 111 of the arm 110, such that the turnstile arm opening 58 faces the end tip 111. The turnstile arm recess 60 in the turnstile cover 10 may have an inner diameter, designated D in FIG. 5, that is greater than an outer diameter, designated D1 in FIG. 7A, of the turnstile arm 110, such that the turnstile cover 10 may be slid over the turnstile arm 110 in the direction indicated by the arrow designated X in FIG. 7. Thus, the turnstile cover 10 is slid on the turnstile arm 110 like a glove. There may be a friction fit between the inner layer 30 of the turnstile cover 10 and the exterior surface 111 of the turnstile arm 110 to ensure the turnstile cover 10 remains on the turnstile arm 110. After installation on the turnstile arm 110, the turnstile cover 10 may be removed by applying an opposite force to the turnstile cover 10 in a direction away from the turnstile 100, i.e., in the direction of the arrow designated Y in FIG. 7. In another preferred embodiment, the inner layer surface 34 which contacts the turnstile arm 110 may be textured an may have ridges or protrusions 35, as shown in FIG. 11, to enhance the friction fit with the turnstile arm 110. In another preferred embodiment, the inner diameter D of the turnstile cover 10, when in a relaxed position, may be less than that the outer diameter D1 of the arm 110, such that the turnstile cover 10 is held to the turnstile arm 110 with both a compression and friction fit. Such an embodiment is possible, because the turnstile cover 10 may be made of flexible resilient materials. In another preferred embodiment, the turnstile cover 10 may be made without the end member 54, as previously mentioned.

The turnstile cover 10 may advantageously slid on and off the turnstile arm 110, so that covers with different printed indicia 20 are readily installable on the turnstile arms 110, or so that the turnstile cover 10 may be washed or replaced. In another preferred embodiment, an adhesive may be used to join the turnstile arm 110 and turnstile cover 10. The turnstile cover 10 may then be cut off of the turnstile arm 110, and any remaining adhesive on the turnstile arm may be washed off the turnstile arm 110.

In addition, because the inner layer 30 of the turnstile cover 10 is padding and is capable of absorbing energy, a person may advantageously walk through the turnstile arms 110 without experiencing painful impacts when forcing on the arms 110. Thus, bruising caused by turnstile arms 110 is advantageously eliminated by the covers 10. For example, some turnstiles 100 have readers and the user swipes a card through the reader, thus allowing the turnstile arms to be turned or rotated. Turnstiles 100 equipped with readers for use with swipe cards are well known to those having ordinary skill in the art and are therefore not described herein. If there is a problem, i.e., the reader fails to read the swipe card or there is a problem with the swipe card, the person's momentum will, in all likelihood, cause the person to walk into and impact the turnstile arm 110, at which time the person will come to an abrupt stop, because the turnstile arms 110 will not rotate. This is often quite painful, because the turnstile arms 110 are made of metal. The user may then again swipe the card through the reader, and if assuming there is no problem, the person will be able to walk through the turnstile 100. Thus, the turnstile arms 110 are made to be user friendly by the use of the covers 10 that are padded.

In addition, the turnstile cover 10 may be readily changed to reflect new advertising or other printed indicia 20. The turnstile cover 10 may advantageously used in connection with virtually any type of turnstile 100, for example the turnstile cover 10 may be used with a vertical type turnstile having horizontal arms as well as the turnstile shown in FIGS. 7 and 8. Vertical turnstiles are well known to those having ordinary skill in the art.

The turnstile cover 10 provides a method for generating income. In one of the preferred embodiments, the exterior surface 14 of the turnstile cover 10 has printed indicia 20, as previously described. The printed indicia 20 may include, for example, advertising, messages, alerts, logos, etc. Interested corporations, governmental entities, private individuals, charities, non-for profit organizations, or virtually any entity or person interesting is delivering a message to people, may, for a fee, purchase covers 10 with virtually any conceivable message printed thereon. For example, a corporation may purchase covers 10 with printed indicia promoting the corporation, or advertising products sold by the corporation. The corporation may pay a fee to have the covers 10 with advertising printed indicia 20 used on the turnstiles 100. The corporation may pay a monthly fee, a weekly fee, or a fee to cover any desired length to of time. Thus, the turnstile cover 10 advantageously provides a useful tool for generating revenue when turnstile covers 10 are sold to buyers.

In another preferred embodiment of the turnstile cover is a tube cover 140, as shown in FIG. 11A, the tube cover 140 comprises a tube 142 which is elongated. The tube 142 has opposed first and second tube ends 144, 146, and the tube 142 has an interior tube surface 148 that defines a tube recess 150 that extends through the tube 142. The first tube end 144 has an opening 152 that leads to the tube recess 150. In one of the preferred embodiments the tube 140 comprises open-cell neoprene or rubber, and may have an inner diameter, designated DT, that is less that the diameter D1 of the turnstile arm 110. Thus, the tube cover 140 is capable of being slid on and off the turnstile arm 110 like a glove. The exterior tube surface 154 has printed indicia 20 that is the same as previously described and which may have advertising, etc., the same as previously described in connection with the first embodiment. Use of the tube 142 advantageously decreases production and allows for mass production of the tube covers 140. In other preferred embodiments, both the first and second ends of the tube 140 are open. The tube cover 140 may, in other embodiments, comprise the materials from which the outer layer 12 may, described in connection with the first embodiment. Other suitable materials may be used.

Another preferred embodiment is shown in FIGS. 12-16. As shown in FIGS. 14 and 15, there is a traffic control system 200 having a traffic control mechanism 202 from which extends a traffic control gate 204 (also referred to herein as barrier 204) that is pivotally connected to the traffic control mechanism 202 by a pivot 206. The traffic control mechanism 202 is capable of raising and lowering the traffic control gate 204, such that the traffic control gate 204 is capable of being pivoted on a pivot 206 in a direction away from the ground 104 as indicated by arrow S in FIG. 15, and then back toward the ground as indicated by arrow T in FIG. 15. When the traffic control gate 204 is in the raised position, traffic, which may be human or vehicular (not shown) can move under the traffic control gate 204. In addition, before the traffic control gate 204 raises, the driver of the vehicle stops the vehicle to pay a toll or produce identification credentials. Or, the driver may have to stop the vehicle to wave an electronic pass card to activate the traffic control system 200 and the traffic control gate 204 raises. Electronic pass cards to activate traffic control mechanisms 202 are well known to those having ordinary skill in the art. Each time the vehicle driver slows or stops the vehicle as he or she approaches the traffic control gate 204, the vehicle driver must visually look at the traffic control gate 204 to make sure that he or she does not impact the traffic control gate 204, and to make sure that the traffic control gate 204 has risen such that the vehicle may drive under the traffic control gate 204. Traffic control mechanisms systems 200 and associated traffic control mechanisms 202, their construction, control and operation are well known to those having ordinary skill in the art. In addition, some traffic control gates are mounted on a hinge and swing horizontally out of the way to allow for vehicles to pass. Traffic control gates that swing horizontally are well known to those having ordinary skill in the art.

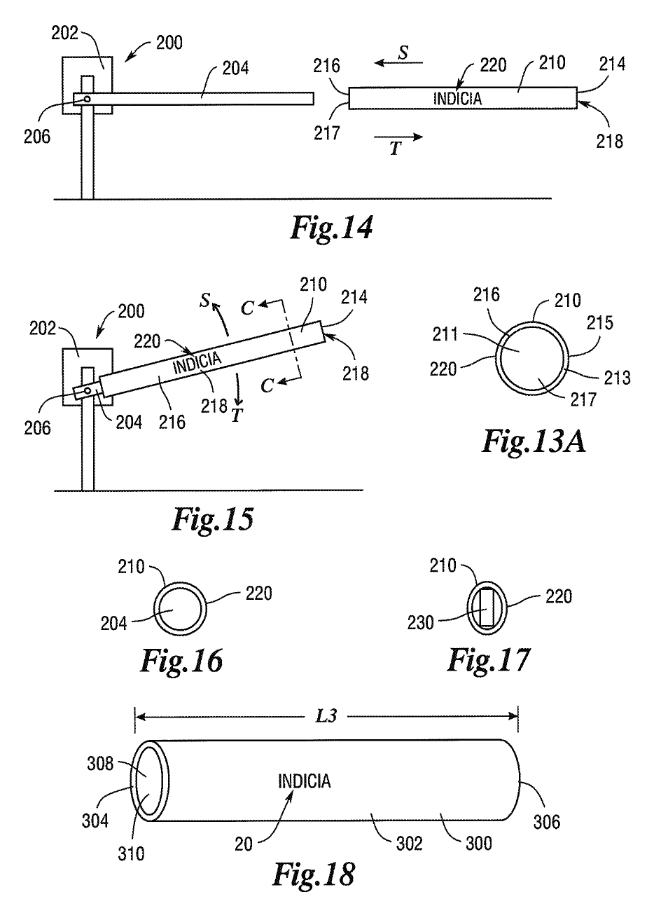

As shown in FIG. 12, the traffic control gate cover 210 (also referred to herein as gate cover 210) has a body portion 212 that is elongated, and has opposed first and second ends 214, 216, respectively. The first end 214 may be closed or sealed by sewing or other suitable means to form a closure 218. The second end 216 has an opening 217 as shown in FIG. 13A. In another preferred embodiment, each of the first and second ends 214, 216, has an opening 217, that is, neither is sealed. As shown in FIG. 13, which is a sectional view taken along line B-B, the traffic control gate cover 210 has an interior 211 that is hollow, and has an interior dimension such that it capable of being fitted around the traffic control gate 204. The traffic control gate cover 210 is slid on and off of the traffic control gate 204 in the directions indicated by arrows S and T in FIG. 14 like a glove. The traffic control gate cover 210 is preferably made of a resilient material. In one of the preferred embodiments the traffic control gate 204 compresses against the traffic control gate 204, such that it is held thereon by a friction fit. The traffic control gate 210 is slid on and off the traffic control gate 204 in the directions of arrows S and T in FIG. 14. FIG. 16 is a view taken along line C-C and shows the traffic control gate cover 210 fitted over and abutting against the traffic control gate 204.

In one of the preferred embodiments, the traffic control gate cover 210 is made of a thermoplastic or synthetic rubber liner 213 with a closely woven textile jacket 215 positioned around the liner, and they are joined. The jacket 215 may comprise cotton and polyester or synthetic materials, canvas, fabrics, woven fabrics, epoxy, plastics, leather, synthetic leather, and the materials from which the above described outer layer 12 of turnstile cover 10 is made, and may be made in the same manner as the outer layer 12 of the turnstile cover 10. And, in another preferred embodiment, the traffic control gate cover 210 may be made from a section of fire hose. It is pointed out that virtually any type of flexible resilient fire hose may be used, for example, a fire hose having a double jacket constructions include a second closely woven jacket for extra durability. Or, the traffic control gate cover 210 may be made of a covered fire hose having an all-polyester single jacket hose that is spirally wrapped with a neoprene or synthetic rubber outer covering. Fire hoses and the method of making fire hoses is well known to those having ordinary skill in the art. Other suitable materials may be used for the traffic control gate cover 210

The exterior surface 220 of the traffic control gate cover 210 has indicia 20, for example advertising. The indicia 20 may be applied after the traffic control gate cover 210 has been made. The indicia 20 is be the same as previously described, and include at least one of the following: advertising, promotional information, public service messages, alerts, logos, and other suitable indicia. In addition, stickers 21 may be applied to the exterior surface 220 of the traffic control gate cover 210. The traffic control gate cover 220 provides a method for generating revenue. Interested corporations, governmental entities, private individuals, charities, not-for profit organizations, or virtually any entity or person interesting is delivering a message to the public may, for a fee, purchase traffic control gate covers 220 with virtually any conceivable message printed thereon. For example, a corporation may purchase traffic control gate covers 220 with printed indicia promoting the corporation, or advertising products sold by the corporation. The corporation may pay a fee to have the traffic control gate covers 220 with advertising printed indicia 20 used on the turnstiles 100. The corporation may pay a monthly fee, a weekly fee, or a fee to cover any desired length to of time. Thus, the traffic control gate cover 220 advantageously provides a useful tool for generating revenue when covers 10 are sold to buyers. For example, the traffic control gate cover is therefore usable to generate advertising revenue for the mass transit authorities, sporting arenas, and other venues. The printed indicia 20 on the traffic control gate cover 210 is may be embodied to have different colors, patterns or designs, and may be made to have corporate logos.

FIG. 17 shows another embodiment wherein the traffic control gate cover 210 is used in combination with a traffic control gate 230 having a rectangular cross section. The traffic control gate cover 210 is resilient and is thus capable of working in combination with a traffic control gate 230 having a rectangular cross section.

Another preferred embodiment of the traffic control gate cover 300 is shown in FIG. 18, and the traffic control gate cover 300 includes a tube cover 302 that is structurally similar to the above-described tube cover 140, shown in FIG. 11A, with one of the differences being that the length, designated L3 in FIG. 18, of the tube cover 302 is greater than the length, designated L2 in FIG. 11A, of the tube cover 140. Another difference is that the inner dimension of the of the traffic control gate cover 300 is sized such that it may be fitted over the traffic control gate 230. At least one of the first and second ends 304, 306 of the tube cover 302 has a tube opening 308, such that the tube cover 302 may be slid on the traffic control gate 230. The tube opening 308 leads to a hollow interior 310. In another preferred embodiment, both the first and second ends 304, 306 are open. In one of the preferred embodiments the tube cover 302 comprises open-cell neoprene, and is slid on an off the traffic control gate 230 like a glove. Tue tube cover 302 may be one piece. The exterior tube cover surface 304 has printed indicia 20 that is the same as previously described indicia 20. Use of the tube cover 302 advantageously decreases production and allows for mass production of the tube covers 302. The tube cover 140 may, in other embodiments, comprise the materials from which the outer layer 12 may, described in connection with the first embodiment. Other suitable materials may be used.

It will be appreciated by those skilled in the art that while the cover and the traffic control gate cover have been described above in connection with particular embodiments and examples, the invention is not necessarily so limited, and other embodiments, examples, uses, and modifications and departures from the described embodiments, examples, and uses may be made. All of these embodiments are intended to be within the scope and spirit of the invention.

What is claimed:

1. A cover for use with a turnstile through which people pass and having at least one turnstile arm, the cover comprising:
a body portion having an outer layer and an inner layer and wherein the inner and outer layers are joined;
the body portion having a first end and an opposed second end and wherein the second end has a turnstile arm opening that leads to a turnstile arm recess; and
wherein the body portion is capable of being moved on and off of the at least one turnstile arm through the turnstile arm opening and wherein the body portion is held to the at least one arm to prevent the body portion from sliding off the turnstile arm.

2. The cover according to claim 1 wherein the inner layer includes padding for absorbing energy such that the padding absorbs energy when impacted by people passing through the turnstile upon contacting the body portion.

3. The cover according to claim 1 wherein the outer layer has an exterior surface and printed indicia is printed on the outer surface such that the printed indicia is visible to people passing through the turnstile.

4. The cover according to claim 3 wherein the printed indicia is at least one of the following: an advertisement, promotional information, a public service message, emergency information, a design, a corporate logo, a team logo, a slogan, printed text, and a pattern.

5. The cover according to claim 3 further including a sticker having printed indicia and wherein the sticker is adhered to the exterior surface with an adhesive.

6. The cover according to claim 1 further including an end member that is connected to the first end to close the first end.

7. The cover according to claim 2 wherein the padding is at least one of the following: resilient foam, open cell neoprene, synthetic leather, plastic, fabric, woven and non-woven fabrics, and leather.

8. The cover according to claim 1 wherein an inner diameter of the turnstile arm recess is greater than an outer diameter of the turnstile arm such that the cover is capable of being slid over the turnstile arm.

9. The cover according to claim 1 wherein an inner diameter of the turnstile arm recess is less than the an outer diameter of the turnstile arm such that the cover is capable of being slid over the turnstile arm and held thereon with a friction fit.

10. The cover according to claim 1 wherein the outer layer comprises at least one of the following:
synthetic leather, plastic, woven materials, non-woven materials, fabric, leather and rubber, and neoprene.

11. The cover according to claim 1 wherein the first end is open and the body portion is hollow.

12. A tube cover for use with a turnstile through which people pass and having at least one turnstile arm, the tube cover comprising:
a tube having a first end first end and an opposed second end and wherein the second end has an opening that leads to a tube recess;
wherein the tube is held to the at least one arm by a friction fit to prevent the tube from sliding off the turnstile arm;
and the tube having an exterior tube surface with printed indicia such that the printed indicia is visible to people passing through the turnstile; and
wherein the tube is one piece.

13. The tube cover according to claim 12 wherein the tube comprises at least one of the following materials:
neoprene, synthetic leather, plastic, woven materials, non-woven materials, fabric, leather and rubber.

14. A traffic control gate cover for use with a vehicular traffic, the traffic control gate cover comprising:
an body portion having opposed first and second ends, and at least one of the first and second ends having an opening;
the body portion having an interior that is hollow, such that the body portion is capable of being slid on and off the traffic control gate through the opening; and
the body portion having an exterior surface and indicia printed on the exterior surface such that the indicia is visible to vehicular traffic.

15. The traffic control gate cover according to claim 14 wherein the printed indicia includes at least one of the following:
an advertisement, promotional information, a public service message, emergency information, a design, a corporate logo, a team logo, a slogan, printed text, and a pattern.

16. The traffic control gate cover according to claim 14 wherein the traffic control gate is one piece.

17. The traffic control gate according to claim 16 wherein the traffic control gate includes at least one of the following:
neoprene, synthetic leather, plastic, woven materials, non-woven materials, fabric, leather and rubber.

18. A method for generating income comprising:
providing a turnstile having at least one arm;
providing a cover having an exterior surface;
selling space on the exterior surface of the cover for the placement of printed indicia to a buyer in exchange for a fee;
printing the indicia on the exterior surface of the cover; and
sliding the cover over the turnstile arm such that the printed indicia is visible to people passing through the turnstile.

19. The method according to claim 18 further including providing the cover with padding.

20. The method according to claim 18 wherein the printed indicia includes at least one of the following: an advertisement, promotional information, a public service message, emergency information, a design, a corporate logo, a team logo, a slogan, printed text, and a pattern.

21. A method for generating income comprising:
providing a traffic control gate;
providing a traffic control gate cover for use with a traffic control gate, and the traffic control gate cover having an exterior surface;
selling space on the exterior surface of the traffic control gate cover to a buyer for a fee, the space on the exterior surface for the placement of indicia;
printing the indicia on the exterior surface of the traffic control gate cover; and
sliding the traffic control gate cover over the traffic control gate such that the indicia is visible to people passing through the traffic control gate.

22. The method according to claim 21 wherein the printed indicia includes at least one of the following: an advertisement, promotional information, a public service message, emergency information, a design, a corporate logo, a team logo, a slogan, printed text, and a pattern.

23. The method according to claim 21 wherein the traffic control gate cover includes at least one of the following: neoprene, synthetic leather, leather, plastic, woven materials, non-woven materials and rubber.
